(19) United States
(12) Patent Application Publication
(10) Pub. No.: US 2021/0279533 A1
(43) Pub. Date: Sep. 9, 2021

(54) CALIBRATION OF A PRINT ENGINE

(71) Applicant: HP Indigo B.V., Amstelveen (NL)

(72) Inventors: Oron Ambar, Ness Ziona (IL); Rodolfo Jodra Barron, Boise, ID (US); Vladimir Shalmai, Ness Ziona (IL); Haim Vladomirski, Ness Ziona (IL)

(73) Assignee: HP Indigo B.V., Amstelveen (NL)

(21) Appl. No.: 16/334,640

(22) PCT Filed: Oct. 17, 2016
(86) PCT No.: PCT/US2016/057354

§ 371 Date: Mar. 19, 2019

(51) Int. Cl. G06K 15/02; G03G 15/04; G03G 15/043; G06K 15/12

(52) U.S. Cl. CPC G06K 15/027; G06K 15/1214; G03G 15/043; G03G 15/04072

(57) ABSTRACT

In one example, a calibration of a print engine may include producing an image by scanning imaging elements along a scan direction, the image having a calibration portion that is continuous or unbroken in a direction perpendicular to the scan direction. Information indicative of an optical measurement of the calibration portion is received. A contribution to the optical measurement associated with each of the laser elements in the group of laser elements is determined. A calibration adjustment for the laser elements in the group of laser elements is determined.

### BACKGROUND

Some printing processes write multiple pixels simultaneously. For example, in a digital press using the liquid electro-photographic (LEP) process laser elements may be used to write pixels onto a photo conductive medium, and multiple laser elements may be used in parallel.

### BRIEF DESCRIPTION OF THE DRAWINGS

Examples are further described hereinafter with reference to the accompanying drawings, in which:

FIG. 1 is a block diagram showing an example of a print engine.

FIG. 2 shows a schematic example of a photo imaging subsystem.

FIG. 3a shows an input calibration image.

FIG. 3b illustrates an adjustment applied to imaging elements.

FIG. 3c illustrates a printed image.

FIG. 4a shows a input calibration image.

FIG. 4b illustrates an adjustment applied to imaging elements.

FIG. 4c illustrates a printed image.

FIG. 4d shows an example output calibration image.

FIG. 4e shows the results of a calibration process.

FIG. 5 illustrates a calibration image.

FIG. 6 illustrates a method of calibrating an imaging system.

FIG. 7 illustrates a computer readable medium in communication with a processor.

### DETAILED DESCRIPTION

In some printing devices, an image to be output is formed from a number of consecutive swathes. Each swathe may include multiple lines of pixels, with the lines of a swathe being generated in parallel by a number of imaging elements or writing elements. Non-uniformity between the imaging elements may lead to unwanted artifacts in the final image. In particular, the periodic nature of the swathes may lead to periodic artifacts that are particularly noticeable.

Individual calibration of the imaging elements may ameliorate the presence of these artifacts. However, in some cases the imaging elements may interact with each other, such that individual calibration does not lead to a uniform output of the imaging elements when the imaging elements are operating together.

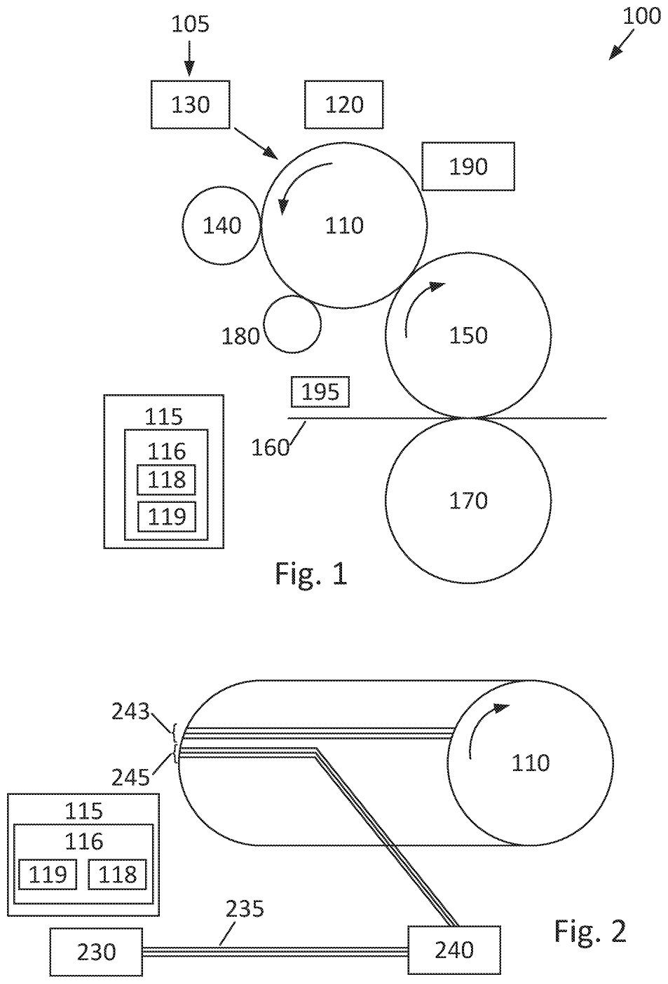

FIG. 1 is a block diagram showing an example of an LEP print engine 100 according to some examples. The surface of photo imaging plate (PIP) 110 receives a uniform electric charge by operation of a charging unit 120. In the following examples, the PIP is described as a photoconductive drum 110, but other arrangements are possible, such as a photoconductive belt. Received image data 105 is received by photo imaging subsystem 130, and laser elements within the photo imaging subsystem 130 selectively illuminate the surface of the photoconductive drum 110, such that areas exposed to the illumination are discharged. This results in an electrostatic image (a so-called latent image) being produced on the drum 110, the electrostatic image corresponding with the image to be printed. The latent image is developed by developing module 140 applying liquid toner to the surface of the drum 110. The toner selectively adheres to the surface of the drum 110, for example adhering to the discharged portions of the surface of the drum 110 (and not to charged portions), to form a toner image on the drum 110. Discharging module 180 removes charge remaining on the drum 110, for example by illuminating the drum with light from a lamp. The return image is then transferred to an intermediate transfer roller 150, and toner remaining on the drum is removed at cleaning station 190. Where different types of toner are used in the same image, for example where each toner is a different colour in colour printing, multiple toner images may be applied to the roller 150 in successive rotations of the drum 110. The intermediate transfer roller 150 may heat the toner image that is received from the drum 110 to evaporate a carrier of the toner. The image is then transferred from the intermediate transfer roller 150 to a print medium 160 as the medium 160 passes to a nip between the intermediate transfer roller 150 and a pressure roller 170.

A control section 115 may be provided to control the various components of the print engine 100. The control section may include one or more processors, volatile and/or nonvolatile memory for storing instructions to be executed by the processors and data for use by the processors. In some examples, the control section 115 may be distributed between the various components of the print engine 100.

A measurement section 195 may be provided to measure an optical property of the printed image. For example, the measurement section may include an in-line camera, in-line scanner, in-line spectrophotometer, or similar device. The measurement section 195 may be external to the print engine 100.

The control section 115 may include a print engine controller 116. The print engine controller 116 may, inter alia, determine a calibration adjustment for laser elements of photo imaging subsystem 130. The print engine controller 116 may include an image generation module 118 to control the laser elements to produce an image by scanning the laser elements along a scan direction such that the image has a calibration portion that is continuous in a direction perpendicular to the scan direction and produced by at least a group of the laser elements. The print engine controller 116 may also include a calibration module 119 to receive information indicative of an optical measurement of the calibration portion, determine a contribution to the optical measurement associated with each of the laser elements in the group of laser elements, and determine a calibration adjustment for the laser elements in the group of laser elements. In some examples, the optical measurement may be performed by measurement section 195.

FIG. 2 shows a schematic example of the photo imaging subsystem 130 of FIG. 1. An array of lasers 230 is controlled by the control section 115 based on the received image data 105 to write a latent image on the surface of the drum 110. For simplicity, the array of lasers 230 is illustrated in FIG. 2 as having 3 lasers, however other numbers of lasers could be used, for example the array may include 12, 18, 28, 36 or 40 lasers. An array of N lasers will write successive swathes, each swathe having N lines of pixels. According to some examples, each swathe may have a width, in the circumferential direction of the drum, of 0.37 mm, 0.56 mm or 0.87 mm, and for each laser the spot incident on the surface of the drum may have a diameter of around 31 μm. Other swathe widths and laser spot sizes may alternatively be used.

FIG. 2 schematically illustrates a completed swathe 243 and a swathe in the process of being written 245. Optical elements 240 may be provided to control the path of the laser beams. For example, a rotating polygonal mirror may be provided to scan the beams from the lasers across the surface of the drum 110. Other optical elements, such as lenses, etc., may also be provided. The drum 110 may rotate about its axis in order to allow successive swathes to expose different parts of the surface of the drum 110.

The power received from a laser of the array 230 at the surface of the drum 110 may vary across the swathe, in the scan direction, due to differences in the optical path as the laser beams are scanned across the drum, for example. Differences in the optical path may be due to the optical design, or production tolerances of the optical elements. Such variation in received laser power may lead to differences in the optical spot shape on the surface of the drum 110 across the swathe. This may result in dot area non-uniformity in the printed image. This may, in turn, lead to visible artifacts in the printed image.

Some devices allow for individual laser elements of the array to be controlled independently of the image data. For example, some printing devices provide a format correction feature that allows the laser power to be varied along the scan direction. In some examples, format correction may allow the power of each laser to be independently varied at intervals along the scan direction. In some examples, the intervals each correspond to 1 millimeter along the scan direction of the printed image. In some examples, the format correction feature may be implemented by controlling a current provided to each laser element in each interval. In other examples, a pulse width of the laser may be controlled instead of, or in addition to, the current provided to laser. In some devices, the laser profile to be applied using format correction may be controlled as 1^{st} or 2^{nd} order polynomials, with parameters of the polynomials being selected to reduce or minimize measured artifacts according to a trial-and-error approach. In some examples, a two-dimensional array indicative of the corrections to be applied to the lasers using format correction may be stored to a file, and loaded on demand when format correction is to be applied. One dimension of the array may correspond to a location along a scan direction, and the other dimension of the array may correspond to the laser element in the array of laser elements. The approach using polynomials derived using trial-and-error may become less effective as the number of laser elements is increased.

Variation in power between the laser beams 235 of the laser array may lead to a lack of uniformity in the final image. As described above, optical power density non-uniformity may lead to non-uniformity of the dot area on the medium. Non-uniformity between the laser elements of the array of laser elements may lead to periodic disturbances in the final image, known as scan band artifacts. Such variation can be caused by differences between the individual laser elements, but may also be caused by interference or crosstalk between the lasers during operation. A calibration of the lasers may be performed by printing a test image or calibration image and measuring an optical property of the printed image, for example using measurement section 195, and adjusting the power of each laser based on a comparison between a target optical property and the measured optical property. In order to associate a measured portion of the printed image with a particular laser of the array, the lasers may be controlled such that, in a region of the image, no more than one laser is operational at a particular time, such that it is clear which laser wrote a particular part of the image. However, calibration based on this arrangement does not address variation in laser output due to interference or crosstalk between the lasers, since this occurs when multiple lasers of the array are operated together and does not occur when the lasers are operated separately. Furthermore, calibration of the lasers becomes increasingly difficult as the number of lasers in the array increases.

In some devices, input data 105 describing an image to be printed does not directly control which laser elements of the array of laser elements writes a particular dot of the output image. Accordingly, when the data describing a test image or calibration image is provided to the photo imaging subsystem 130, it may be difficult or impossible to predict which part of the image will be written by any particular laser element.

The array of laser elements 230 (also referred to herein simply as lasers) may be provided in a writing head unit, and may be embodied as individual laser elements, as multiple channels of a single laser device, as a plurality of laser devices that each have multiple channels, etc. Herein, references to adjacent lasers refers to lasers that write adjacent lines (the lines being along the scan direction) on the surface of the drum, such that the portions written by adjacent lasers are adjacent (in the medium transport direction) in the final image.

According to some examples, the arrangement of FIG. 2 may include a control section 115, as described above.

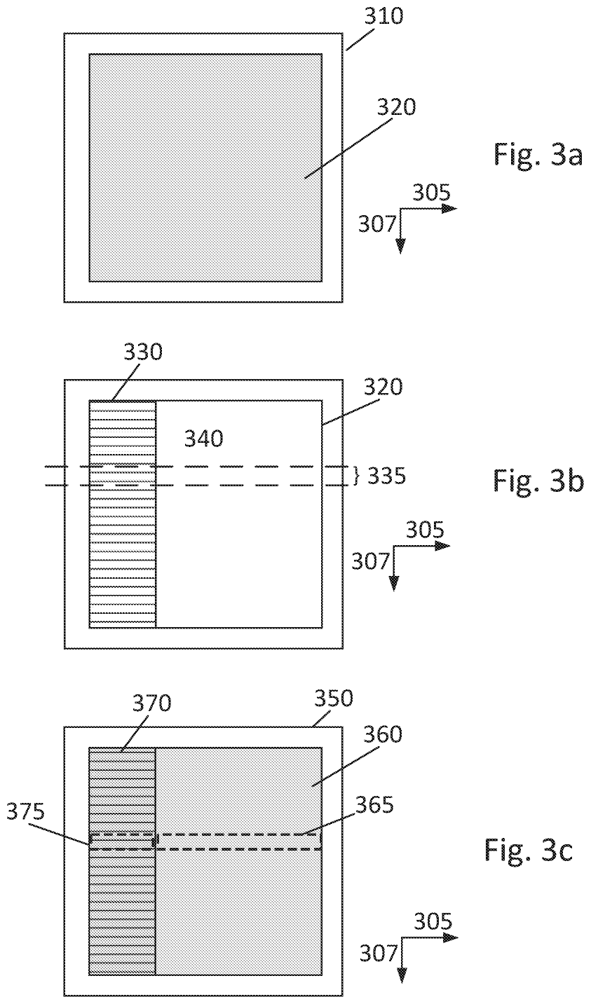

FIGS. 3a to 3c show an example of a calibration image for use in calibrating laser elements of the array to ameliorate variation between the laser elements. FIG. 3a shows an input calibration image 310. Data describing the input calibration image 310 is to be provided to the photo imaging subsystem 130. The input calibration image includes an input calibration region 320, which will be measured by the measurement section 195 for use in calibrating the lasers. In the example of FIG. 3a, the scan direction 305 is illustrated horizontally. The vertical direction may correspond to a medium transport direction 307, which is perpendicular to the scan direction 305 and corresponds to a direction on the printed image along which the medium is transferred to the printing device during the printing process.

FIG. 3b illustrates an adjustment applied to the laser element output power, for example using the format correction feature. Within the area corresponding to the input calibration region 320, the laser element output power is adjusted to produce a registration region 330 and a calibration region 340. In the calibration region 340 the laser element power is controlled as in normal printing; this may involve no adjustments to the laser element power, or may involve applying a previously established correction for use in normal printing, for example. In the registration region 330 one or more of the laser elements are controlled to produce an output that is different to that indicated by the input calibration image 310. In some examples, registration region 330 may be positioned next to the calibration region 340 in a scanning direction 305, such that a swathe, such as that indicated as 335, includes parts of both the registration region 330 and the calibration region 340. In some examples the registration region 330 and the calibration region 340 may be wider (in the medium transport direction) than a swathe, such that multiple swathes combine to form the registration region 330 the calibration region 340.

FIG. 3c illustrates the resulting printed image 350, which includes a calibration area 360 corresponding to the calibration region 340 of FIG. 3b and a registration area 370 corresponding to the registration region 330 of FIG. 3b. The calibration area 360 may include one or more calibration portions 365, and the registration region 370 may include one or more registration portions 375.

In some examples, the calibration portion 365 may be continuous or unbroken in a direction perpendicular to the scanning direction 305 (i.e. in the medium transport direction 307), such that the calibration portion 365 does not have any gaps in the medium transport direction 307. A continuous or unbroken calibration portion 365 may be associated with concurrent operation of the laser elements within the laser array during production of the calibration portion 365. Accordingly, when the laser array is subject to non-uniformity associated with interference or crosstalk between the laser elements, this non-uniformity is likely to be represented in the calibration portion 365. The continuous portion may be wider than two swathes in the medium transport direction. In examples where it is difficult to control which laser element writes which part of an input image, a continuous portion wider than two swathes results in a portion of the continuous area in which all lasers operate concurrently.

The registration portion 375 is arranged such that reference to the registration portion 375 allows a determination of a correspondence between parts of the calibration portion 365 and the respective laser elements that produced those parts. In some examples, the registration portion may indicate a location of the calibration portion.

The printed calibration image 350 may be measured by measurement section 195, and this measurement may include a measurement of an optical property of the calibration portion of the image. The registration portion 375 may be referenced to determine a start and end of the calibration portion 365; this may facilitate determination of a contribution to the measured optical property associated with individual laser elements of the array of laser elements. For example, in the arrangements of FIG. 3c, the registration portion 375 may be used to determine the start and end of the calibration portion 365 (in a medium transport direction 307). The calibration portion 365 thus determined may be divided into rows of equal width, with the rows oriented along the scan direction 305, and with the number of rows being equal to the number of laser elements in the laser array. In some examples, the location of the calibration portion may be determined based on the registration portion; this may, in turn facilitate associating laser elements with respective contributions to the calibration portion 365.

Based on the measured optical property associated with each of the rows of the calibration portion 365, discrepancies between the lasers may be evaluated, and corrections or calibration adjustments may be determined for each laser in order to reduce these discrepancies. The corrections or calibration adjustments may be implemented using the format correction functionality, where it is available.

The measured optical property may be used to generate a profile of the laser array, the profile of the laser array indicative of variations between the laser elements by representing variation in the calibration portion of the printed image along a direction 307 perpendicular to the scan direction. According to some examples, the profile of the laser array is generated by averaging the measured property in the scan direction 305; this may smooth the profile from noise and local halftone screen structures. The profile produced in this manner may then be divided into N sub pixels (e.g. using interpolation) where N is the number of laser elements, in order to map parts of the profile to individual laser elements.

The profile may be converted to laser power using a predetermined factor, and a negative of the resulting laser power may be applied to the laser power profile to correct for detected variations between the laser elements.

The measured optical property may include gray values of the image measured by a scanning device, for example. The measurement may include scanning an image and evaluating a gray value at each pixel of the scanned image. For example, where the scan has 8 bits per pixel, each pixel may have a value from 0 to 255, with 0 representing black and 255 representing white. A profile of the measured grayscale data may be produced by averaging the measured pixel values along the scan direction (here, scan direction refers to the direction of scanning of the laser elements, as that direction maps onto the printed image, rather than any scanning that may be involved in measuring the image). The average values produce a profile, corresponding to one-dimensional data representative of the variation in grayscale values along the medium transport direction within the calibration portion 365. In this example, the average is performed before associating the parts of the profile with particular laser elements. However, in some examples, each of the pixels measured in the calibration portion 365 may be associated with a laser element, and the grayscale values of the pixels associated with each laser element may be averaged, to produce a respective averaged grayscale value for each laser element.

In some examples the measured property may be used to evaluate a dot area ratio or a dot area percentage. For example where a grayscale measurement renders values from 0 to 255, the following may calculation may be performed, where gray(measure) is the measured gray value of a pixel of interest (or an average of values measured over a group of pixels of interest), gray(blank page) is a measured or predetermined grayscale value of the medium (in the absence of toner, ink, printing liquid etc.), and gray(solid) corresponds to a measured or predetermined value representative of 100% dot area (100% coverage).

$$Inversed\_gray = 255 - gray ( measure )$$

$$Inversed\_page = 255 - gray ( blank page )$$

$$Inversed\_solid = 255 - gray ( solid )$$

$$Dot area = ( Inversed\_gray - Inversed\_page ) / ( Inversed\_solid - Inversed\_page ) \\ = ( gray ( page ) - gray ( measure ) ) / ( gray ( page ) - gray ( solid ) )$$

The calibration area 360 of FIG. 3c may include a plurality of calibration portions 365 in the medium transport direction 307, and an average may be performed across the plurality of calibration portions 365. In some examples, respective profiles may be determined for each of a plurality of the calibration portions 365, and these profiles may then be averaged to produce an averaged profile. Using the averaged profile for the determination of the calibration adjustments may reduce noise and/or sensitivity to local print quality defects. For example, a profile may be generated for each calibration portion 365 by averaging measured values along a scan direction, as described above, and the resulting profiles of calibration portions that are aligned along the medium transport direction 307 may then be averaged to produce an average profile. Parts of the average profile may then be associated with respective laser elements by dividing the profile by the number of laser elements, as described above. Other methods of averaging across calibration portions 365 are also possible. For example, the pixels in the calibration portions may each be assigned to a respective laser element, and then for each laser element an average may be performed over the pixels assigned to that laser element.

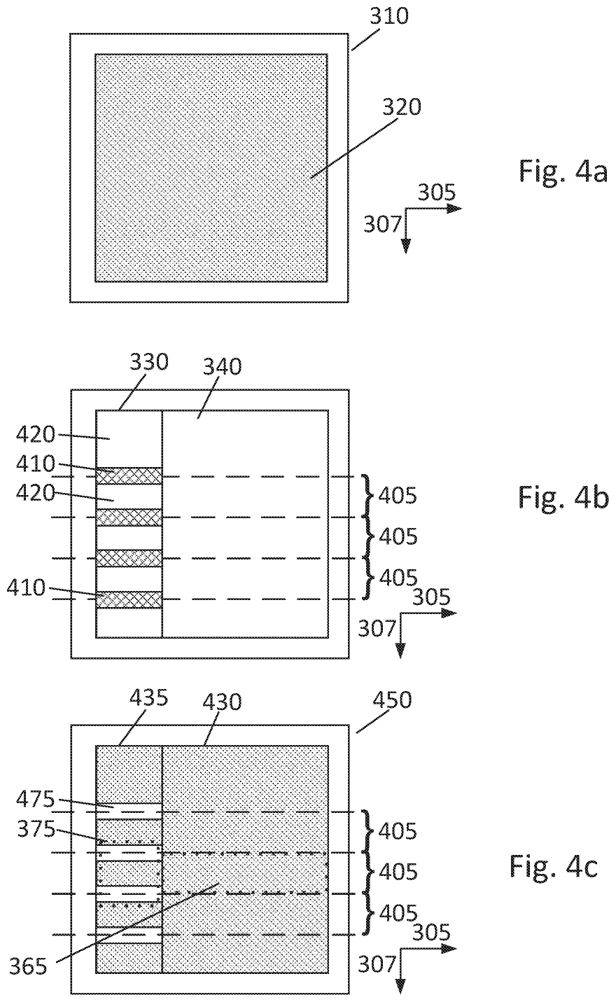

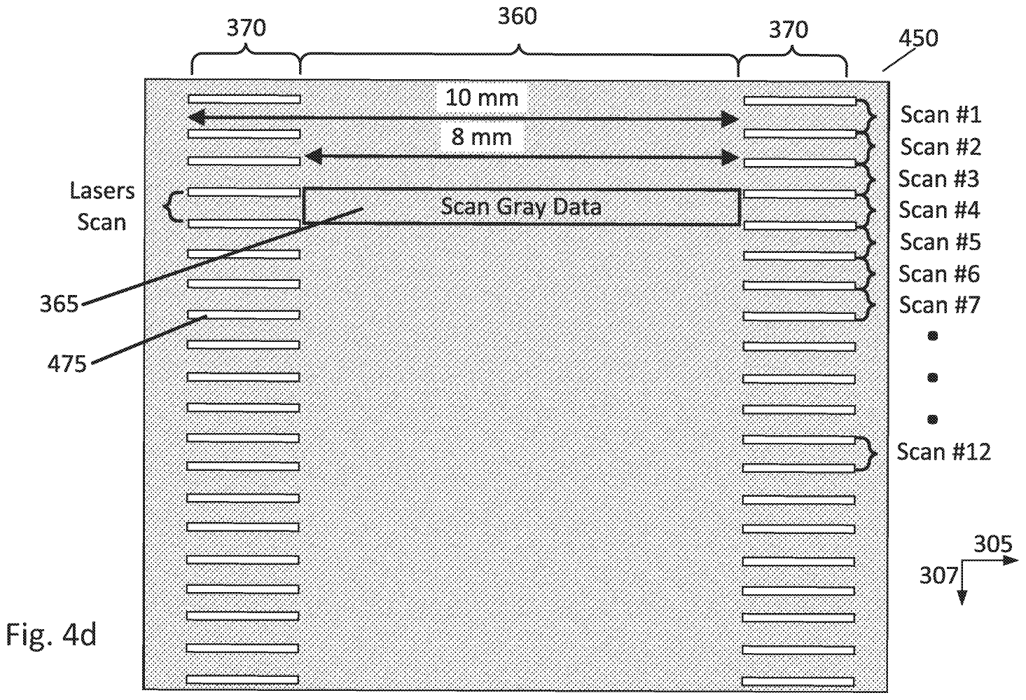

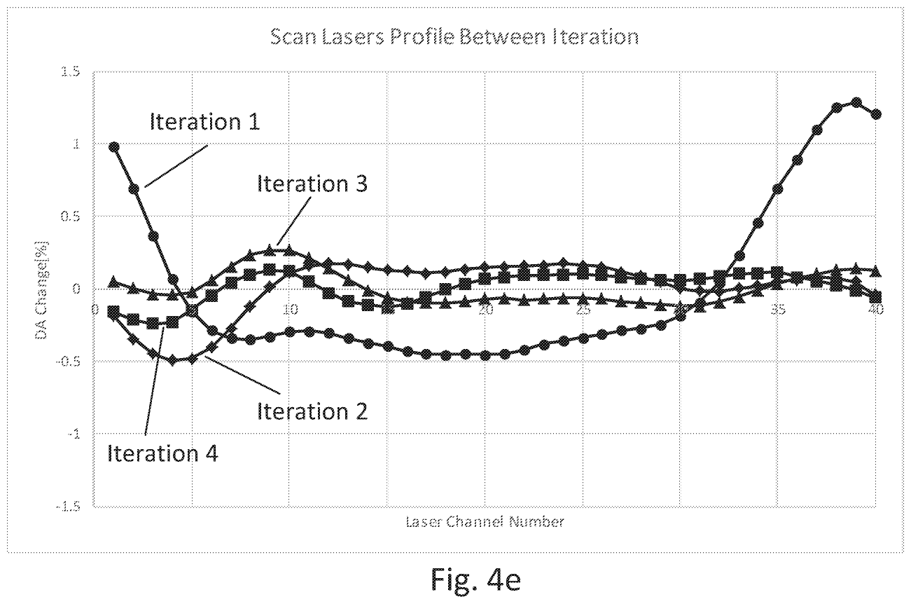

FIGS. 4a to 4c show a calibration image consistent with FIGS. 3a to 3c according to some examples. FIG. 4a shows the input calibration image having an input calibration region 320 that is a continuous, uniform grey area.

FIG. 4b illustrates the adjustment applied to the power outputs of the individual laser elements. Dotted lines indicate swathes 405. In the example of FIG. 4b the adjustment to the power of the laser elements in the registration region 330 has a similar effect to applying a mask. In masked region 410, which is shown with hatched shading, the laser power is set to differ from the value indicated by the input calibration image. For example, the laser power may be set to 0%, such that the laser is effectively turned off in the masked region 410. In the remaining parts 420 of the registration region 330, and in calibration region 340, no adjustment of the laser power of the individual laser elements is applied (or alternatively, a predetermined adjustment for use in normal printing may be applied).

In the example of FIG. 4b, the masked region 410 corresponds to the first and last 3 elements of the laser array, such that the first and last 3 lines of each swathe are not written in the registration region 330.

FIG. 4c illustrates the resulting printed image. As in FIG. 4b, dotted lines are used to indicate swathes, and are not part of the printed image. The beginning and end of each swathe is indicated in the registration area 370 by registration marks 475, corresponding to masked regions 410. For example, where the masked region 410 corresponds to the first and last 3 lines (where each line corresponds to one of the laser elements) of each swathe, the centroid of the registration mark 475 corresponds to the end of one swathe and the beginning of the next (possibly excluding the first and last swathes of the calibration area 360). Accordingly, the part of the calibration area 360 corresponding to each swathe may be approximately identified, permitting the identification of a calibration portion 365 of the calibration area 360. An example calibration portion 365 is shown with a dotted line in FIG. 4c. There may be a plurality of calibration portions 365 in the calibration area 360. For example, each swathe 405 of the calibration area 360 may be a calibration portion 365. The calibration portion 365 may be entirely contained in the calibration area 360. In the example of FIG. 4c each calibration portion 365 corresponds to one swathe of the calibration area 360, but other relationships between swathes and the calibration portions 365 are possible. For example, a calibration portion 365 may be produced by a plurality of consecutive swathes, or may be produced by a predetermined portion of a swathe. The number of swathes, or the portion of the swathe, that produced the calibration portion 365 may be taken into account when mapping contributions to the measured optical property to the laser elements.

In some examples an edge of a registration mark 475 may be used to indicate the beginning and/or end of a calibration portion 365. However, in some examples, using a centroid of the registration mark 475 may provide a more accurate indication of the relationship between particular laser elements and the printed image.

Each calibration portion 365 may have a corresponding registration portion 375, shown by a dotted line in FIG. 4c. In the example of FIG. 4c, the registration portion 375 includes the registration marks 475 that were produced, in part, by the swathe that produced calibration portion 365. As the registration marks 475 of this example are produced by in part by the swathes preceding and following the swathe that produced calibration portion 365, the registration portion may have a greater width in the medium transport direction 307 than the calibration portion 365. A plurality of calibration portions 365 may be present in a calibration area 360. If two consecutive swathes used as respective calibration areas 365, the respective registration portions 375 may overlap.

FIG. 4d shows an example output calibration image 450 according to some examples. In the arrangement of FIG. 4d, registration areas 370 are provided on either side of a calibration area 360.

In the example of FIG. 4d, the input data corresponds to a uniform grey across the whole of the calibration area 360 and registration area 370. The registration marks 475 are generated by controlling the laser power, e.g. using a format correction capability, to adjust the laser power. In the arrangement of FIG. 4, the laser power of the first and last three lasers (in an array of 28 lasers) is adjusted to 0% across the registration area 370 in each swathe. This results in registration marks 475 with uniform spacing. Registration marks 475 with non-uniform spacing may be used in some examples. Uniform spacing of the registration marks 475 may simplify some aspects of generating the marks and using the marks to determine a start and end of a calibration portion 365. In the example of FIG. 4d, the centroid (in the medium transport direction) of each registration mark (possibly except the first and last registration marks) corresponds to an end of one swathe and the beginning of another swathe in the medium transport direction.

A calibration portion 365 is shown (annotated as “Scan Gray Data”) in FIG. 4d. However, any swathe of the calibration area 360 (numbered as scan #1 . . . scan #12 in FIG. 4d) may be used as a calibration portion 365. In some examples, multiple consecutive swathes may be used as a calibration portion 365.

In the example of the calibration portion 365 of FIG. 4d, the calibration area 360 has a width in the scan direction 305 of 8 mm and each of the two illustrated registration areas 370 has a width in the scan direction 305 of 2 mm. However, alternative widths in the scan direction 305 may be selected.

The printed calibration image 450 may be measured by measurement section 195, as described above. The registration portion may be referenced to determine a start and end of the calibration portion; in the arrangement of FIG. 4d, this is facilitated by the registration marks 475 positioned around the start and end of a swathe in the medium transport direction and the extend of the calibration portion 365 in the medium transport direction corresponding to a swathe. The registration marks 475 may facilitate identification of a particular laser element (or subset of the laser elements) that wrote a particular line (extending along the scan direction) of the image, such that a contribution to an image (and a corresponding measured optical property) may be associated with particular laser elements of the array of laser elements.

The calibration portion 365 may thus be identified in the measured image, and may be divided in the medium transport direction 307 into contributions associated with respective elements of the laser array, for example by assuming that the lasers of the laser array contribute equally to the extent of the image in the medium transport direction and dividing the measured calibration portion 365 accordingly.

After the corrections or calibration adjustments have been determined, the process may be repeated taking these adjustments into account (i.e. applying these adjustments when writing the calibration region 340). Thus, variations between the lasers can be reduced in an iterative fashion, until a detected variation is below a predetermined threshold, or to a maximum number of iterations has been reached. In some examples, the variation is evaluated based on a dot area profile derived from the optical measurement of the printed image.

In the arrangement of FIG. 4d, the calibration portion 365 may be determined using one registration portion (e.g. the registration portion 375 on the left hand side of the calibration portion 365 in FIG. 4d) or more than one registration portion (e.g. the registration portions 375 on either side of the calibration portion 365 in FIG. 4d).

FIG. 4e shows the results of an example calibration process performed using a calibration image 450 as shown in FIG. 4d. The horizontal axis shows the laser channel number (laser element) and the vertical axis shows the dot area determined from the calibration image 450 as a percentage of the target dot area (as defined in the input calibration image 310). FIG. 4e shows the result of applying four successive iterations, with each iteration including the generation of a calibration image 450, measuring the printed calibration image 450, and determining an adjustment for each of the laser elements based on the measurement, as described above. The adjustment determined in one iteration is applied when generating the printed calibration image (and the calibration area 360, in particular) in the next iteration. As can be seen, the percentage change in dot area is generally reduced in each iteration, relative to the previous iteration, indicating that the dot area generally approaches the target dot area through the application of the determined corrections in successive iterations. In the example of FIG. 4e there are 40 laser elements in the laser array.

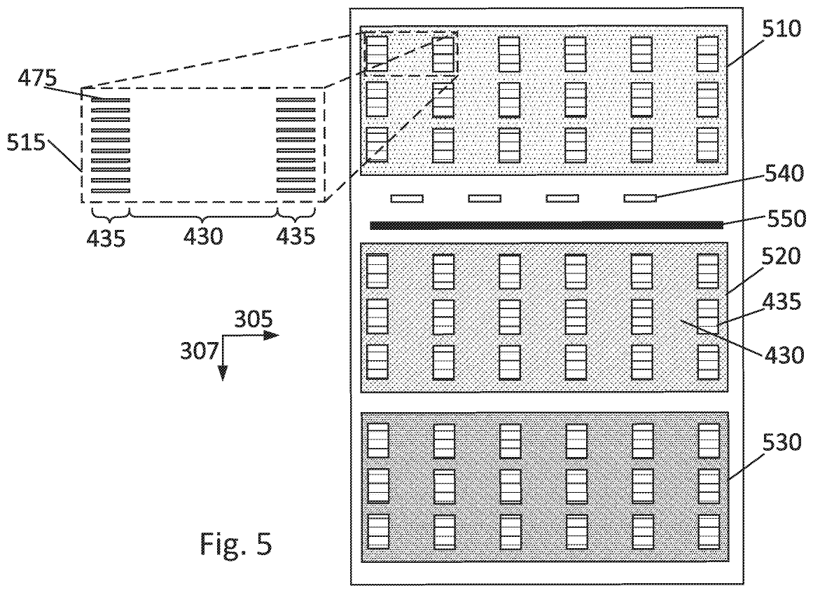

FIG. 5 illustrates a calibration image according to some examples.

FIG. 5 includes first 510, second 520 and third 530 calibration image sections. Each of the first 510, second 520 and third 530 calibration image sections includes respective calibration areas 360 and registration areas 370, as illustrated in the expanded portion 515. The calibration areas may include registration marks 475. The calibration area 360 and registration area 370 illustrated in FIG. 5 are as described in relation to FIG. 4d, but other arrangements may be used. Each of the first 510, second 520 and third 530 calibration image sections has a different gray coverage.

In some examples, non-uniformity between laser elements may depend on a target gray coverage to be written by the laser elements. Where multiple calibration image sections are provided with different gray coverage in the calibration image, it is possible to base the calibration on more than one gray coverage. According to some examples, the calibration may be performed based on a single one of the calibration image sections; for example, a predetermined one of the calibration image sections. In some examples, each of the calibration image sections 510, 520, 530 may be measured, and one of the calibration image sections may be selected for use in calibrating the lasers, based on the measurements. For example, a calibration image section in which the median or maximum non-uniformity is detected may be selected to calibrate the lasers.

In some examples, a correction may be determined based on two or more calibration image sections, for example based on an average or weighted average across the different image sections (e.g. an average of the measured optical property associated with a particular laser element in different calibration image sections, or an average of corrections determined for a particular image element based on respective calibration image sections).

In some examples, different calibration factors may be determined for each laser and for each measured gray coverage, and different calibration factors may be applied depending on a gray coverage to be written. For example, curve fitting or interpolation may be used to approximate a correction/calibration for gray coverages that have not been directly measured.

Position fiducials 540 may be provided to facilitate matching the measured image position to the printed image on the medium (e.g. when the measurement device is an in-line scanner).

A normalization portion 550 may be provided in order to facilitate normalization of the gray levels. For example, normalization portion 550 may be a solid black region indicative of 100% coverage (e.g. 100% dot area). This area may be measured to determine a value for the gray(solid) parameter.

The calibration image sections 510, 520, 530 of FIG. 5 include a plurality of calibration areas 360 in the scan direction 305. According to some arrangements, a calibration may be performed for each calibration area 360 along the scan direction in order to derive, for each laser, separate corrections for areas of the swathe corresponding with respective calibration areas. According to this arrangement, the calibration may ameliorate variations in incident laser power along a scan direction. For the purposes of such a calibration, the registration portions 375 may be calibrated using the same adjustment as a neighboring calibration portion 365.

If the calibration portions 365 and registration portions 375 are arranged as in FIG. 4d, and have lengths in the scan direction of 8 mm and 2 mm, respectively, with no separation in the scan direction, a correction factor may be determined separately for each laser for each 10 mm part of the scan direction, such that the same correction is applied in a portion of the scan direction corresponding to each neighboring calibration portion 365/registration portion 375 pair.

The calibration image sections 510, 520, 530 of FIG. 5 include a plurality of calibration areas 360 in the medium transport direction 307. In some examples, profiles may be determined for a plurality of the calibration areas that share the same position along the scan direction within the same particular calibration image section 510, 520, 530, and these profiles may then be averaged to produce an averaged profile for that portion of the scan direction and for the gray coverage of that calibration image section 510, 520, 530. Using the averaged profile for the determination of the calibration adjustments may reduce noise and/or sensitivity to local print quality defects. For example, a profile may be generated for each calibration area by averaging measured values along a scan direction, as described above, and the resulting profiles of calibration portions that are aligned along the medium transport direction 307 may then be averaged to produce an average profile. Parts of the average profile may then be associated with respective laser elements by dividing the profile by the number of laser elements, as described above, using the registration portions 375 to associate portions of the scanned image with particular laser elements.

Other arrangements of the elements in FIG. 5 are possible. Further, the various features (e.g. multiple calibration portions 365 in the scan direction, multiple calibration portions 365 in the medium transport direction, multiple calibration image sections 510, 520, 550, position fiducials 540, normalization portion 550) may be provided individually or in any combination.

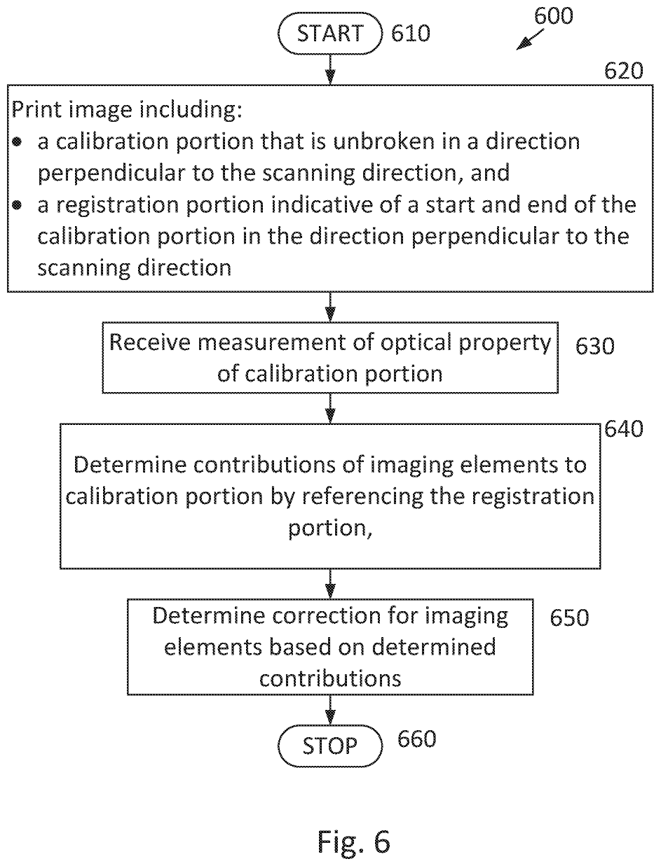

FIG. 6 illustrates a method 600 of calibrating an imaging system according to some examples. The method begins at 610 and at 620 an image is printed, the image including a calibration portion 365 and a registration portion 375. The image may be printed by controlling a plurality of imaging elements (such as laser elements of a write head) of an imaging system to produce the image on a substrate. The image is formed by scanning the imaging elements in a scanning direction (for example, to produce a physical latent image on a PIP that may be developed and transferred to a medium). The calibration portion may be unbroken in a direction perpendicular to the scanning direction, and may be produced by two or more of the imaging elements. The registration portion may indicate a start and end of the calibration portion in the direction perpendicular to the scanning direction. The registration portion may mark the start and end of the calibration portion, or may allow the start and end of the calibration portion to be determined indirectly, e.g. by identifying a part of the calibration portion other than the start/end, with the identified part allowing the start and end of the calibration portion to be determined.

At 360 an optical property of the image is measured, e.g. by an in-line scanner, and the resulting measurement may be passed to a processing element. At 640 the measured image is processed (e.g. by the processing element) to determine a contribution of an imaging element to the calibration portion 365. For example, a line of the calibration portion 365 (along the scan direction) may be determined to have been produced by a particular imaging element. The registration portion may be used in performing the determination of 640.

At 650 a correction to be applied to each of the imaging elements (e.g. a power correction to be applied to a laser element) may be determined based on the contribution of the imaging elements to the calibration portion, as determined at 640. The method terminates at 660. In some examples, the method 600 of FIG. 6 may be iterated. The method 600 may be iterated until a predetermined level of consistency/accuracy is achieved for each of the imaging elements, or until a predetermined maximum number of iterations have been completed.

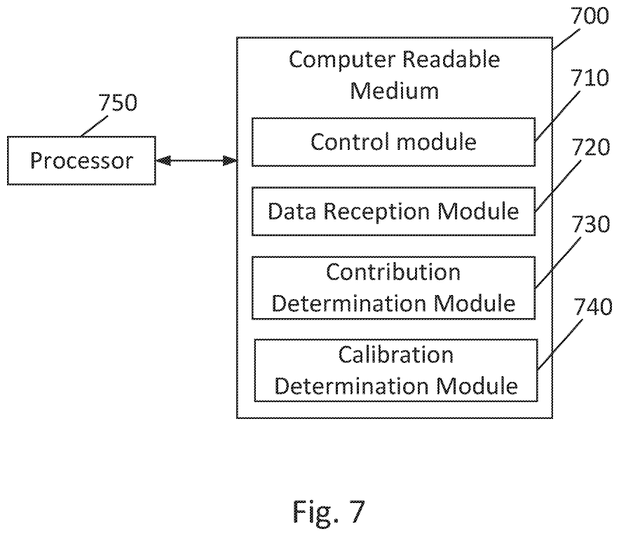

FIG. 7 illustrates a computer readable medium 700 according to some examples. The computer readable medium stores modules, with each module including instructions that, when executed cause a processor 750 or other processing device to perform particular operations. The computer readable medium 700 includes a control module including instructions that when executed cause a processing device 750 to control a plurality of imaging elements to produce an image by scanning the imaging elements along a scan direction, the image having a calibration portion that is continuous in a direction perpendicular to the scan direction and produced by at least a group of the imaging elements. The computer readable medium 700 also includes a data reception module including instructions that when executed cause the processing device 750 to receive data describing an optical measurement of the calibration portion. Further, The computer readable medium 700 includes a contribution determination module including instructions that when executed cause the processing device 750 to determine a contribution to the optical measurement associated with each of the imaging elements in the group of imaging elements. The computer readable medium 700 also includes a calibration determination module including instructions that when executed cause a processing device 750 to determine a calibration adjustment for the imaging elements in the group of imaging elements. The modules of the computer readable medium 700 may cause a processing device 750 to operate in accordance with any of the examples described herein.

In producing a halftone image, various patterns of dots, referred to as screens, may be used, and the screens may be applied at different angles. In some examples, the above calibration may be carried out for one screen and the resulting corrections applied to the imaging elements when printing other screens. In other examples, the calibration may be performed for each screen, and possibly for each orientation/angle of each screen, in order to more reliably correct for variation between imaging elements when the different screens are used. The results of these calibrations may be stored in respective arrays in respective files that may be accessed and applied when a particular screen is to be used.

In the examples above, the registration mark 475 was formed in the first and last three lines of each swathe. However, other arrangements are possible. For example, the registration each registration mark may be entirely within its respective swathe (e.g. if a registration mark includes the last line of a swathe, the first line of the next swathe will not include a registration mark). The registration marks may include more of fewer than six lines. In some arrangements, registration marks having a width of six lines may allow for accurate detection by a scanning device while avoiding a reducing in accuracy due the width of the registration mark in the medium transport direction. In some examples, the laser elements may be controlled differently between successive swathes, such that the registration marks (or parts of registration marks) written in each swathe may differ. In the examples above, the start and end of each calibration portion 365 in the medium transport direction corresponded with one swathe, but other arrangements are possible. For example, each calibration portion may include multiple swathes. In an alternative example, a calibration portion may include half of one swathe and an adjacent half of the next swathe in the medium transport direction. In such an example, the registration mark may correspond to one or more lines at the center of each swathe.

In the examples above, the registration marks 475 are generated by setting a laser power to 0% when writing the portion of the image corresponding to the registration mark, however, other laser power settings may be used, provided the registration mark may be detected by the measurement section 195.

The examples above are described in relation to a grayscale calibration image, but the image may be produced in any color that the printing device can produce. A good contrast between the medium and calibration image is expected to assist in accurate measurement of the printed calibration image. In some examples, a calibration may be carried out using a single color (e.g. a single ink or toner) and applied to printing other colors, while in other examples a separate calibration may be carried out for each ink or toner of the printing device. In this case, a separate look up table of laser power adjustments for each of the inks or toners of the printing device.

According to some examples, the calibration area 430 may be printed using a screen that is used in normal printing, this may improve the similarity between the calibration conditions and the actual printing conditions in normal use. This, in turn may result in improved performance when the calibrated write head is used in normal printing.

The examples above are based on a LEP printing device, but the examples may be applied more broadly to other printing devices and techniques in which an array of elements are arranged to for produce a printed output one swathe at a time.

Throughout the description and claims of this specification, the words “comprise” and “contain” and variations of them mean “including but not limited to”, and they are not intended to (and do not) exclude other components, integers or elements. Throughout the description and claims of this specification, the singular encompasses the plural unless the context implies otherwise. In particular, where the indefinite article is used, the specification is to be understood as contemplating plurality as well as singularity, unless the context implies otherwise.

Features, integers or characteristics described in conjunction with a particular aspect or example are to be understood to be applicable to any other aspect or example described herein unless incompatible therewith. All of the features disclosed in this specification (including any accompanying claims, abstract and drawings), and/or all of the elements of any method or process so disclosed, may be combined in any combination, except combinations where at least some of such features and/or elements are mutually exclusive. Examples are not restricted to the details of any foregoing examples. The Examples may extend to any novel one, or any novel combination, of the features disclosed in this specification (including any accompanying claims, abstract and drawings), or to any novel one, or any novel combination, of the elements of any method or process so disclosed.

1. A print engine controller, the controller comprising:
an image generation module to control a plurality of laser elements to produce an image by scanning the laser elements along a scan direction, the image having a calibration portion that is continuous in a direction perpendicular to the scan direction and produced by at least a group of the laser elements;
a calibration module to receive information indicative of an optical measurement of the calibration portion, determine a contribution to the optical measurement associated with each of the laser elements in the group of laser elements, and determine a calibration adjustment for the laser elements in the group of laser elements.

2. The controller of claim 1, wherein the image includes a registration portion, the registration portion indicative of a location of the calibration portion, and determining a contribution to the optical measurement associated with each of the laser elements in the group of laser elements includes determining a location of the calibration portion based on the registration portion.

3. The controller of claim 1, wherein the calibration module is to determine a contribution to the optical measurement associated with each of the laser elements in the group of laser elements by averaging the optical measurement or a property derived from the optical measurement between a plurality of calibration portions arranged along the direction perpendicular to the scan direction and mutually aligned along the scan direction.

4. The controller of claim 1, wherein:
the image generation module is to control a plurality of laser elements to produce the image such that the image has a plurality of calibration elements at different locations along the scan direction, and
the calibration module is to determine a plurality of sets of calibration adjustments, each set associated with a different one of the locations along the scan direction, and each set including a calibration adjustment for the laser elements in the group of laser elements.

5. The controller of claim 1, wherein:
the image generation module is to control a plurality of laser elements to produce the image such that the image has a plurality of calibration portions, each calibration portion having one of a plurality of different gray coverages, and
the calibration module is to determine the calibration adjustment for the laser elements in the group of laser elements based on optical measurements of two or more calibration portions, the two or more calibration portions including calibration portions having at least two different gray coverages.

6. The controller of claim 1, wherein:
the optical property includes a plurality of gray level values measured in the calibration portion; and
the calibration module is to determine a contribution to the optical measurement associated with each of the laser elements in the group of laser elements by:
averaging the plurality of gray level values in the scan direction to generate a gray profile,
interpolating the generated gray profile to produce an interpolated gray profile, and
assigning parts of the interpolated gray profile to respective laser elements of the group of laser elements by dividing the interpolated gray profile equally between the laser elements of the group of laser elements.

7. A printing device comprising the print engine controller of claim 1.

8. A method of calibrating a print engine, the method comprising:
controlling a plurality of imaging elements of the imaging system to produce an image on a substrate by scanning the imaging elements in a scanning direction, the image including:
a calibration portion produced by a group of the imaging elements, the calibration portion being unbroken in a direction perpendicular to the scanning direction, and
a registration portion produced by one or more of the imaging elements, the registration portion indicative of a start and end of the calibration portion in the direction perpendicular to the scanning direction;
receiving a measurement of an optical property of the calibration portion of the image;
determining, by referencing the registration portion, a contribution to the received measurement due to each of the imaging elements of the group; and
determining a correction for each of the imaging elements of the group based on the determined contributions.

9. The method of claim 8, wherein determining a contribution of each of the imaging elements to the received measurement includes:
determining a profile of the optical property across the calibration portion in a direction non-parallel with the scan direction based on the registration portion, and
associating portions of the profile with respective imaging elements based on a number of imaging elements in the group.

10. The method of claim 9, wherein determining a profile of the optical property includes averaging the optical property in a direction parallel to the scan direction.

11. The method of claim 8, wherein the image includes a plurality of calibration portions and registration portions arranged along the scan direction, and the method comprises:
receiving a measurement for each of the calibration portions,
determining for each of the calibration portions, by referencing a corresponding registration portion, a contribution to the received measurement for that calibration portion due to each of the imaging elements of the group; and
determining for each of the calibration portions, a correction for each of the imaging elements of the group based on the determined contributions.

12. The method of claim 8, wherein the image includes a plurality of calibration portions and registration portions arranged along a direction perpendicular to the scan direction, and the method comprises:
receiving a measurement for each of the calibration portions,
determining for each of the calibration portions, by referencing a corresponding registration portion, a contribution to the received measurement for that calibration portion due to each of the imaging elements of the group; and
determining, for each imaging element, an average of the determined contributions associated with that imaging element among the calibration portions arranged along the direction perpendicular to the scan direction, and wherein
determining the correction for each of the imaging elements includes determining the correction based on the determined average of the contributions associated with the respective imaging element.

13. The method of claim 8, further comprising iterating the controlling, receiving, determining a contribution and determining a correction until a termination condition is reached.

14. The method of claim 8, wherein the image further includes a further calibration portion and a further registration portion, the further calibration portion having a different coverage from the calibration portion.

15. A non-volatile computer-readable medium storing:
a control module including instructions that when executed cause a processing device to control a plurality of imaging elements to produce an image by scanning the imaging elements along a scan direction, the image having a calibration portion that is continuous in a direction perpendicular to the scan direction and produced by at least a group of the imaging elements;
a data reception module including instructions that when executed cause the processing device to receive data describing an optical measurement of the calibration portion;
a contribution determination module including instructions that when executed cause the processing device to determine a contribution to the optical measurement associated with each of the imaging elements in the group of imaging elements; and
a calibration determination module including instructions that when executed cause a processing device to determine a calibration adjustment for the imaging elements in the group of imaging elements.
